(19) United States
(12) Patent Application Publication
(10) Pub. No.: US 2012/0299957 A1
(43) Pub. Date: Nov. 29, 2012

(54) REPLACEMENT OF PICTURE CONTENT IN A LAYOUT

(75) Inventors: David Wayne Waltman, Lake Stevens, WA (US); Stephanie Lyn Arndt, Seattle, WA (US); John Edward Dimmick, JR., Carnation, WA (US)

(73) Assignee: Microsoft Corporation, Redmond, WA (US)

(21) Appl. No.: 13/118,381

(22) Filed: May 28, 2011

(51) Int. Cl. G09G 5/00

(52) U.S. Cl. 345/629

(57) ABSTRACT

Pictures and picture frames are presented in a manner that allows them to be easily disambiguated from one another. Picture content can also be easily swapped between picture frames in a layout. Multiple pictures in a layout might be simultaneously replaced. Pictures might also be inserted into a scratch area for use in a layout in a manner that allows picture content to be easily disambiguated from other picture content and used in the layout.

### BACKGROUND

Certain types of page layout application programs provide functionality for creating layouts of pictures, such as for creating photo books or collages. When multiple pictures are placed in a layout in these types of applications, it is often necessary to rearrange or swap the location of pictures to obtain a desired layout of pictures.

For instance, it may be necessary to rearrange or swap the location of pictures to create a desired photo collage. In order to swap the location of pictures in certain types of page layout applications, it may be necessary to select the pictures to be swapped and to then select picture swap options from within a menu. These types of mechanisms are not easily discoverable or necessarily easy to use.

Some page layout applications might also provide pre-defined templates that include professionally designed picture layouts that can be modified by an end user. In some cases, these picture layouts may be pre-populated with sample pictures. In order to replace the sample pictures, a user might be required to individually replace each picture. This can be a tedious and time-consuming process, especially when a template includes many pages with multiple pictures on each page.

It can also be difficult in certain page layout application programs to insert multiple pictures into a layout without disturbing the existing layout. Moreover, when multiple pictures are inserted into a layout the pictures may be “piled” on top of one another. As a result, it can also be difficult to quickly and easily locate desired pictures in the pile of pictures.

It is with respect to these and other considerations that the disclosure made herein is presented.

### SUMMARY

Technologies are described herein for disambiguating pictures and picture frames in a page layout application program. Concepts and technologies are also disclosed herein for swapping picture content between picture frames in a layout, simultaneously replacing multiple pictures in a layout, and for inserting pictures into a layout in a manner that allows the pictures to be easily disambiguated from other pictures and used in a picture layout.

According to one aspect presented herein, a page layout program provides a user interface for creating layouts of picture content. The user interface includes a layout area where the layout is created and a scratch area. The scratch area may be located adjacent to the layout area and utilized to store picture content, and other types of content, that is not contained in a layout. The scratch area is an unmanaged area in which content may be freely placed, removed, arranged, and utilized.

In order to create a layout, picture frames may be placed into a layout. Picture frames are containers for picture content. Picture frames may include a rectangular or other shaped border, drag handles for resizing the border, and a rotate handle for rotating the picture frame. Using these controls, picture frames may be located, sized, and oriented within a layout. Additionally, picture content may be added to or removed from picture frames without modifying the location, size, or orientation of the picture frames. As used herein, the term “picture content” refers to image data that may be placed inside a picture frame. Picture content might also exist outside of a picture frame. The term “picture” will be utilized herein to refer to a picture frame that includes picture content. In one embodiment, an icon (referred to herein as an “insert icon”) is displayed on picture frames that do not contain content. The insert icon may be selected in order to insert picture content into a picture frame.

According to another aspect, picture content can be easily swapped between two picture frames. In particular, an icon (referred to herein as a “content icon”) is displayed in a picture frame when a user interface cursor, such as a mouse cursor, is placed within the border of a picture. The content icon might be selected using the user interface cursor (such as by selecting a mouse button) and “dragged” (such as by holding a mouse button while moving the mouse). Such a dragging operation causes the picture content to be removed from the picture frame. The picture content might also be displayed semi-transparently while the picture content is being dragged.

If the mouse cursor enters the border of a second picture frame while the picture content is being dragged, the picture content from the first picture frame may be displayed in the second picture frame and the picture content from the second picture frame may be displayed in the first picture frame. In this manner, a preview of the results of a picture content swap operation may be provided.

If the content icon is deselected (such as, for instance, by releasing a mouse button) while the user interface cursor is within a border of another picture frame, the picture content from the first picture frame is swapped with the picture content from the second picture frame. This occurs without modifying the location, size, or orientation of the picture frames. Multiple picture content might also be swapped in a similar manner.

According to yet another aspect, picture content in multiple picture frames on the layout can be easily swapped with picture content in the scratch area. In this embodiment, multiple picture content in the scratch area can be selected. In response to such a selection, a content icon is displayed in each of the selected picture content. One of the content icons may be selected with a user interface cursor and dragged into the layout. The selected picture content might be displayed semi-transparently while being dragged.

If the selected content icon is deselected (such as by releasing a mouse button) while the user interface cursor is within a border of one of the multiple picture frames in the layout, the selected picture content will be inserted into the multiple picture frames in the layout. Picture content in the multiple picture frames might also be moved to the scratch area.

According to another aspect, picture content existing in multiple picture frames in a layout can be replaced with other picture content. In particular, a selection may be made of one or more picture frames containing picture content in a layout. A selection of picture content might also be made to replace the picture content in the picture frames in the layout. A request may then be received to replace the picture content in the picture frames in the layout with the selected picture content. In response to such a request, the picture content in the selected picture frames is replaced with the selected picture content.

The picture content previously in the selected picture frames may be moved to the scratch area. Additionally, any picture content that cannot be placed into a picture frame might also be moved to the scratch area. Picture content previously in the scratch area might be moved in order to make room for the insertion of the new picture content into the scratch area. Picture content in picture frames might also be replaced in this manner without pre-selecting the picture frames for which associated content should be replaced.

According to another aspect, picture content, pictures, and other types of content may be inserted into the scratch area for use in a layout. In particular, a request may be received to insert picture content for use in a layout. In response thereto, a selection of picture content may be received and inserted into the scratch area such that the picture content does not overlap. The picture content shown in the scratch area can then be moved to the layout. For instance, picture content might be moved into a picture frame in the layout. Additionally, picture content in a layout can also be moved to the scratch area.

When picture content is moved to the scratch area, it might be necessary to move picture content, or other types of content, preexisting in the scratch area to make room for the picture content to be inserted. In this case, the preexisting content is shifted in order to make space for the content to be inserted. The picture content to be inserted is then placed in the created space.

Content in the scratch area can be freely arranged. Additionally, a command might be provided for arranging content in the scratch area in order to eliminate any overlap between the content. For instance, picture content in the scratch area might be “tiled” by arranging the picture content in non-overlapping rows and columns of picture content. Other mechanisms might also be utilized to create non-overlapping arrangements of content.

It should be appreciated that this Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIGS. 1-3 are user interface diagrams illustrating aspects of an exemplary operating environment for the concepts disclosed herein, along with various aspects of a mechanism for disambiguating picture content and picture frames utilized in the various embodiments disclosed herein;

FIGS. 4-10 are user interface diagrams illustrating aspects of various embodiments disclosed herein for swapping picture content between picture frames in a layout;

FIG. 11 is a flow diagram showing aspects of one illustrative routine disclosed herein for swapping picture content between picture frames in a layout;

FIGS. 12-14 are user interface diagrams illustrating aspects of various embodiments disclosed herein for simultaneously replacing multiple pictures in a layout;

FIG. 15 is a flow diagram showing aspects of one illustrative routine disclosed herein for simultaneously replacing multiple pictures in a layout;

FIGS. 16-18 are user interface diagrams illustrating aspects of various embodiments disclosed herein for inserting picture content into a layout;

FIG. 19 is a flow diagram showing aspects of one illustrative routine disclosed herein for inserting picture content into a layout; and

FIG. 20 is a computer architecture diagram showing an illustrative computer hardware and software architecture for a computing system capable of implementing the various embodiments presented herein.

### DETAILED DESCRIPTION

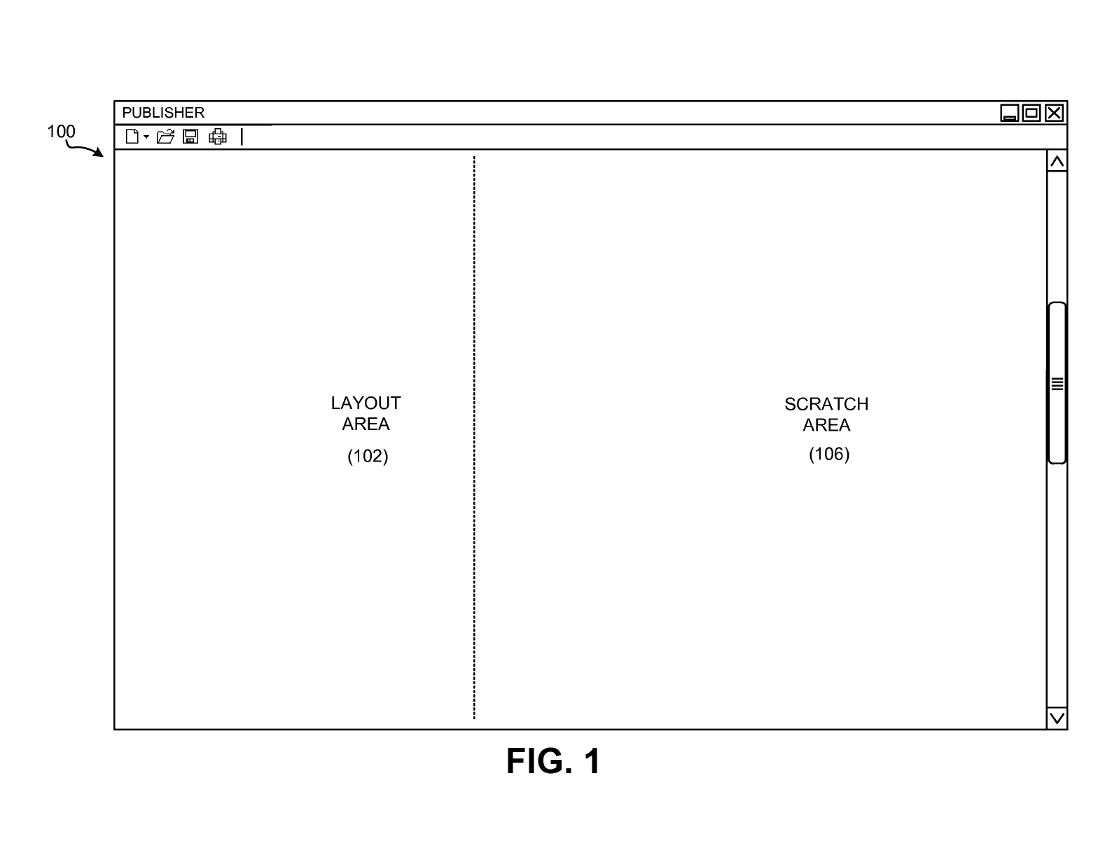

The following detailed description is directed to concepts and technologies for disambiguating pictures and picture frames, swapping picture content between picture frames in a layout, simultaneously replacing multiple pictures in a layout, and for inserting pictures into a layout. As discussed briefly above, using the technologies disclosed herein, picture content and picture frames may be presented in a manner that allows them to be easily disambiguated from one another, picture content can be swapped between picture frames in a layout, multiple pictures in a layout can be simultaneously replaced, and picture content can be inserted into a scratch area for use in a layout in a manner that allows the picture content to be easily disambiguated from other picture content and used in the layout. Additional details regarding these and other features will be provided below with regard to FIGS. 1-20.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration specific embodiments or examples. Referring now to the drawings, in which like numerals represent like elements through the several figures, aspects of a computing system and methodology for disambiguating pictures and picture frames, swapping picture content between picture frames in a layout, simultaneously replacing multiple pictures in a layout, and for inserting pictures into a layout will be described.

FIGS. 1-3 are user interface diagrams illustrating aspects of an exemplary operating environment for the concepts disclosed herein, along with various aspects of a mechanism for disambiguating picture content and picture frames utilized in the various embodiments disclosed herein. In particular, FIG. 1 shows an illustrative user interface 100 provided by a page layout application according to one implementation disclosed herein. The user interface 100 includes a layout area 102 and a scratch area 106 in one embodiment. Another area of the user interface 100 might also be provided for displaying user interface icons or other types of user interface objects for initiating some of the functionality described herein and other page layout functions not disclosed herein.

In this regard, it should be appreciated that the user interface 100 and the remainder of the user interfaces disclosed herein have been greatly simplified for purposes of discussion. The user interfaces described herein might include more or fewer components, might be arranged differently, and might operate in a different fashion while still remaining within the scope of the disclosure provided herein. It should also be appreciated that while various user input devices have been described with respect to the various embodiments disclosed herein, other types of user input mechanisms might also be utilized. For instance, although the various embodiments described herein are disclosed in conjunction with the use of a mouse user input device controlling a mouse cursor, other types of user input devices and mechanisms such as keyboards, touch screens, proximity sensors, voice input, and others may be utilized.

As will be described in greater detail below, the layout area 102 is utilized to create a layout of pictures and, potentially, other types of objects, such as text, audio, video, and multimedia objects. Although the disclosure presented herein is primarily made in the context of a layout of pictures, it should be appreciated that the disclosure is not limited to laying out only pictures in the layout area. Additional functionality provided by the layout area 102 will be provided below.

The scratch area 106 is located adjacent to the layout area 102 in one embodiment. For instance, in FIG. 1, the scratch area 106 is shown as being adjacent to and to the right of the layout area 102. The scratch area 106 might also be above, below, or to the left of the layout area 102. As will be described in greater detail below, the scratch area 106 is utilized to hold picture content, and potentially other types of content, that is not contained in a layout. Content can be moved from a layout to the scratch area 106 or from the scratch area 106 to a layout. Additional details regarding these aspects and other aspects of the scratch area 106 will be provided below.

It should be appreciated that the user interface 100 shown in FIG. 1, and the other FIGURES, is merely illustrative and that other layouts might be utilized. In this regard, it should also be appreciated that the various user interfaces, user interface controls, user interface layouts, and example user interface objects and layouts presented herein are merely illustrative and that other configurations might be utilized.

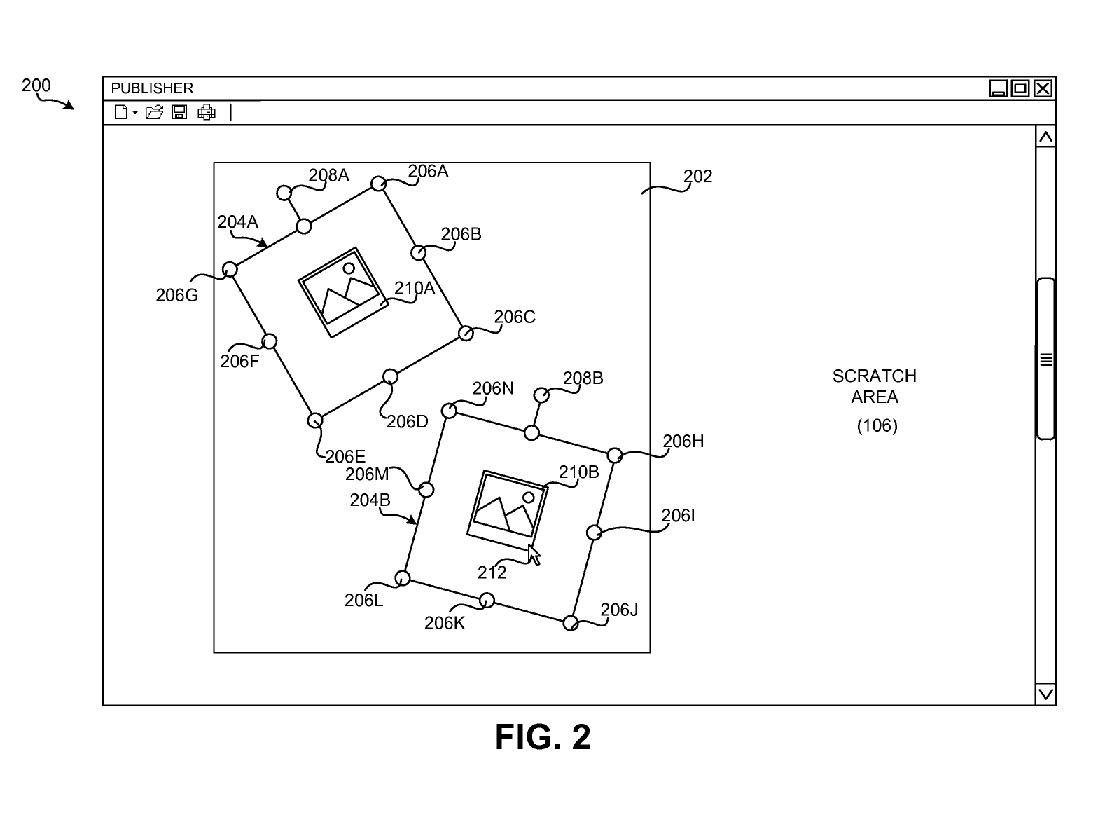

FIG. 2 shows a user interface 200 in which a layout 202 has been created in the layout area 102. Additionally, several picture frames 204A-204B have been created in the layout 202. As will be described in greater detail herein, the picture frames 204A-204B are containers for picture content. The picture frames 204A-204B may include a rectangular or other shaped border, drag handles 206 for resizing the border, and a rotate handle 208 for rotating each picture frame 204A-204B. Using these controls, the picture frames 204A-204B may be located, sized, and oriented within a layout. Picture content within a picture frame 204A-204B is rotated, sized, and positioned along with the picture frame 204A-204B.

Picture content may be added to or removed from the picture frames 204A-204B without modifying the location, size, or orientation of the picture frames. In one embodiment, an icon 210A-210B, respectively, (referred to herein as an “insert icon”) is displayed on picture frames that do not contain content. The insert icon 210A-210B may be selected in order to insert picture content into the respective picture frame 204A-204B. For instance, a file selection user interface may be presented (not shown) in response to the selection of an insert icon 210, such as with a user interface cursor such as a mouse cursor 212. A user then may select picture content for insertion into the respective picture frame 204 through the file selection user interface.

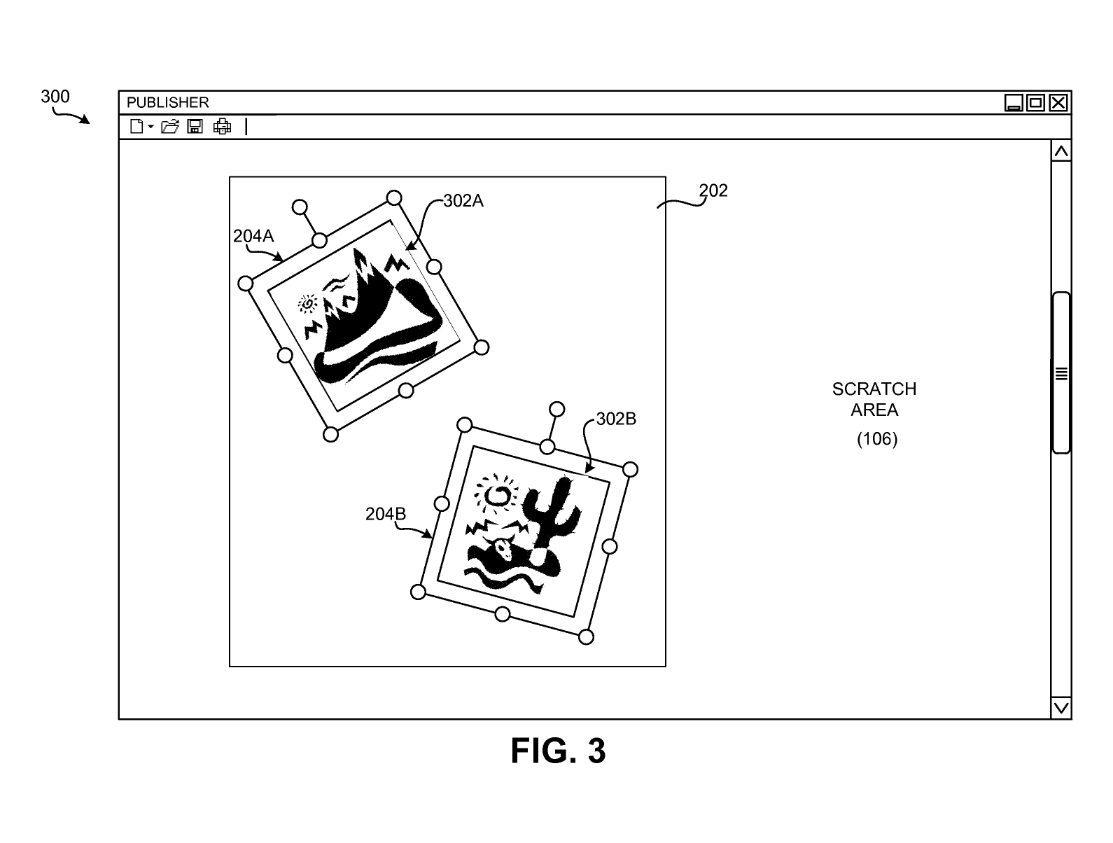

In the user interface 300 shown in FIG. 3, a user has caused picture content 302A-302B to be inserted into the picture frames 204A-204B, respectively. As will be described in greater detail below, the picture content 302A-302B may be removed from the picture frames 204A-204B without modifying the size, location, or orientation of the picture frames 204A-204B. Additionally, new picture content may be inserted into the picture frames 204A-204B also without modifying the size, location, or orientation of the picture frames 204A-204B. In this regard, it should be appreciated that the picture frames 204A-204B can exist (as shown in FIG. 2), without having any picture content 302 associated therewith. Additional details regarding the operation of the picture frames 204A-204B will be provided below.

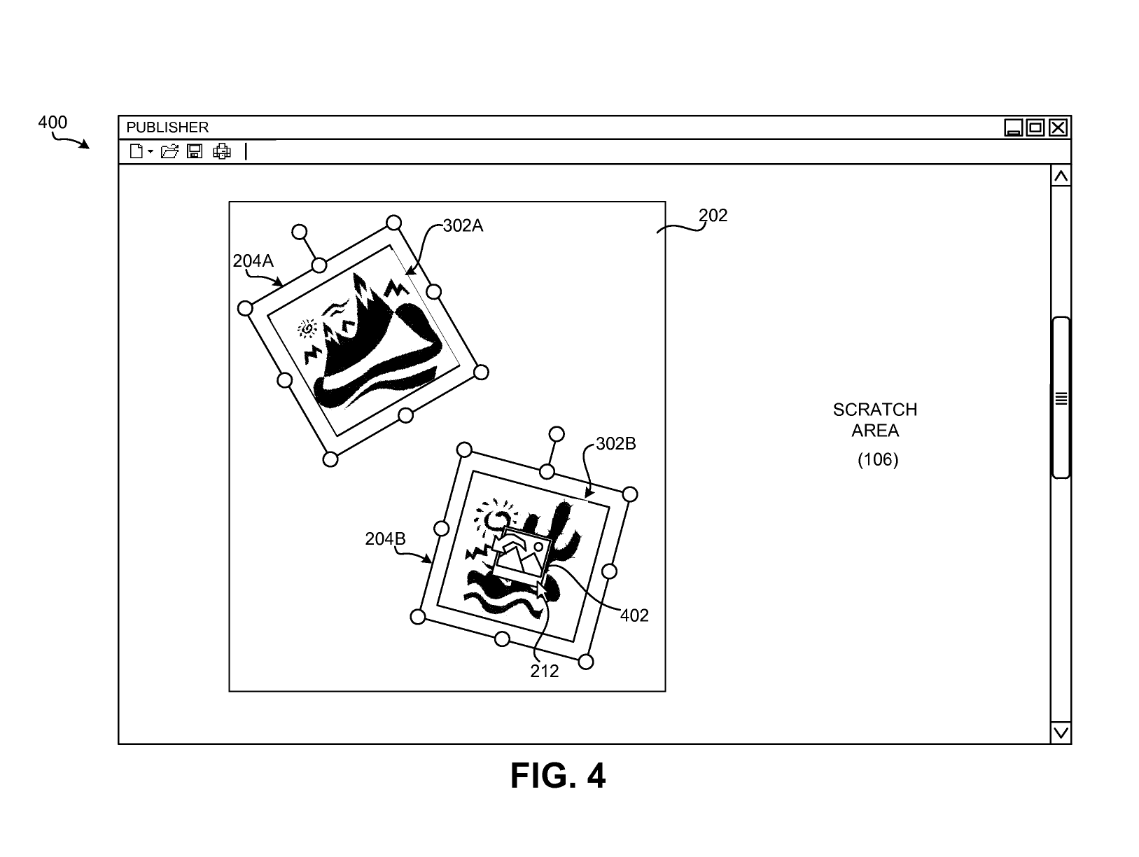

FIGS. 4-10 are user interface diagrams illustrating aspects of various embodiments disclosed herein for swapping picture content between picture frames 204A-204B in a layout. In particular, in the user interface 400 shown in FIG. 4, two picture frames 204A-204B have been placed in a layout 202. Additionally, picture content 302A-302B, respectively, has been inserted into the picture frames 204A-204B.

In the example user interface shown in FIG. 4, the mouse cursor 212 has been placed within the border of the picture frame 204B. As a result, a user interface icon 402 (referred to herein as a “content icon”) has been displayed in the picture frame 204B above the picture content 302B. The content icon 402 is associated with the picture content 302B and indicates to a user that the picture content 302B can be removed from the picture frame 204B. As discussed above, the picture content 302B can be removed from the picture frame 204B without modifying the size, location, orientation, or other properties of the picture frame 204B.

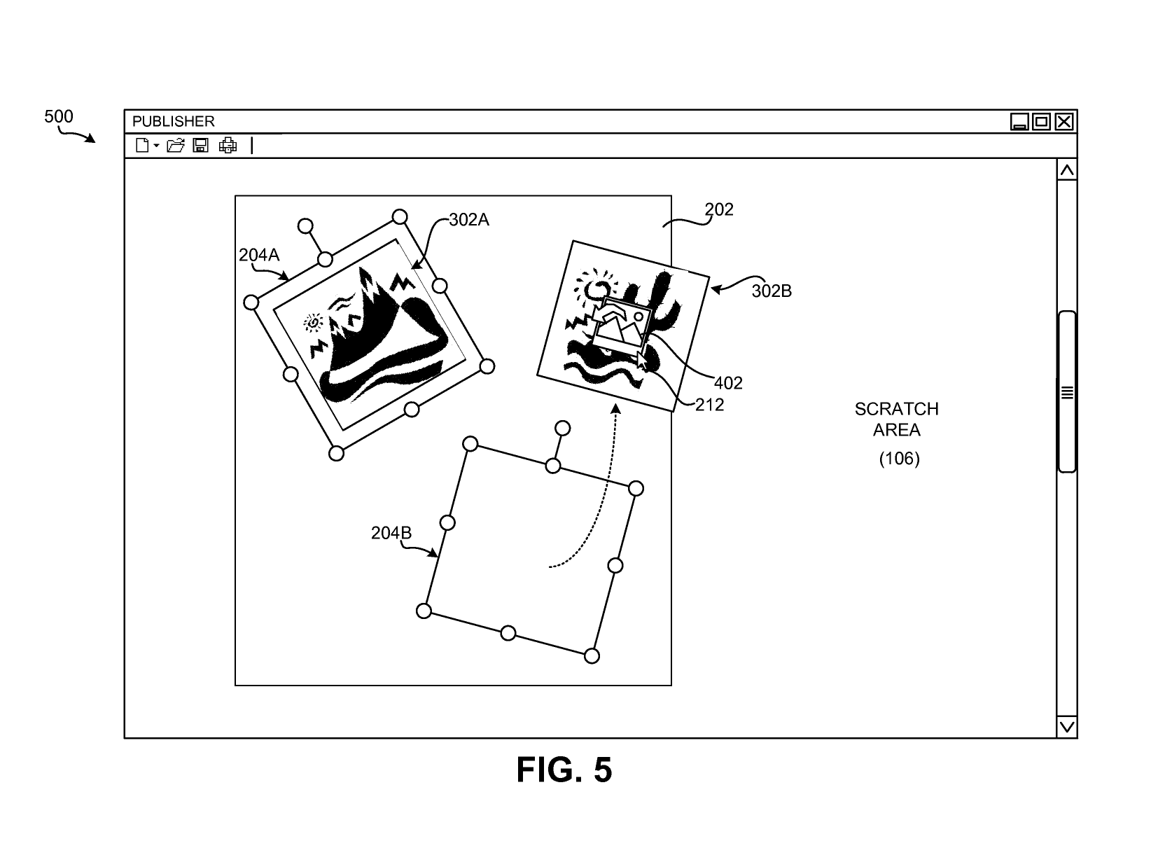

If the content icon 402 is selected, such as using the mouse cursor, and “dragged,” such as by holding down a mouse button and moving the mouse, the picture content 302B will be removed from the picture frame 204B. This is illustrated in FIG. 5. While the picture content 302B is being dragged, the picture content may be displayed in a semi-transparent manner. Other types of visual effects might also be utilized to indicate that the picture content 302B has been removed from the picture frame 204B.

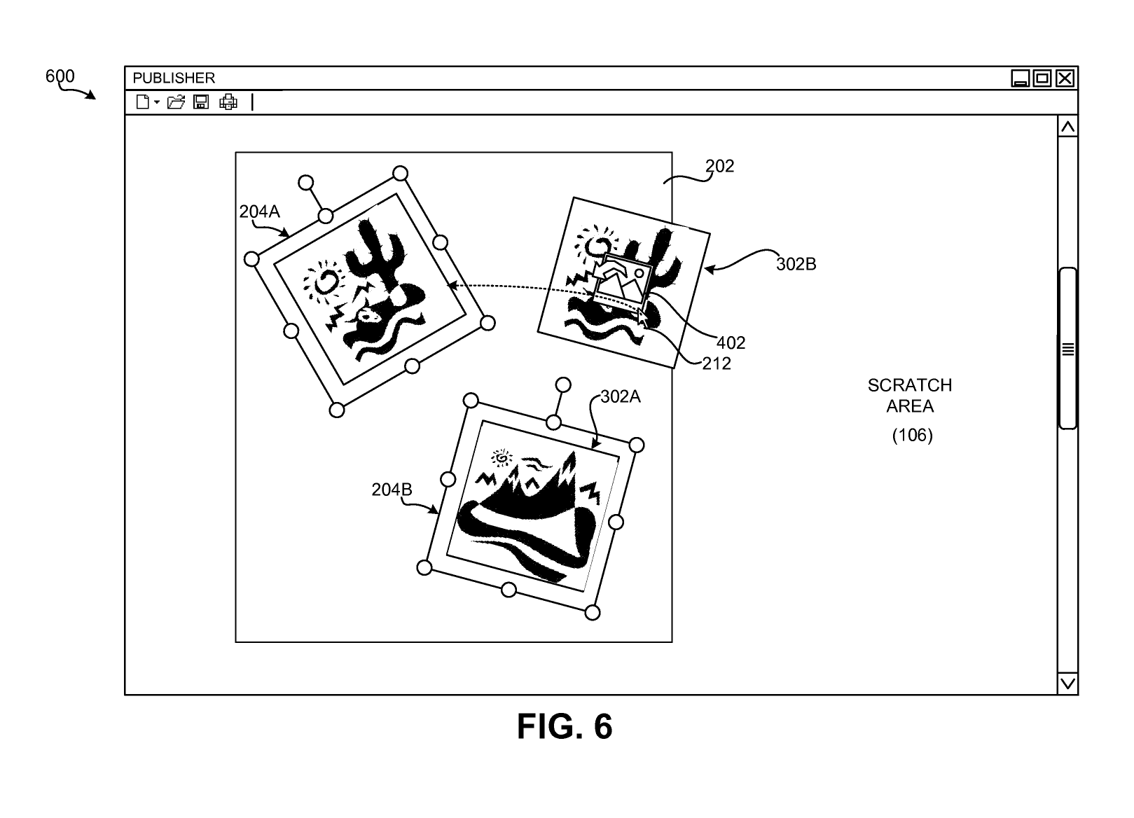

If the mouse cursor 212 enters the border of another picture frame, such as the picture frame 204A, while the picture content 302B is being dragged, the picture content 302B from the picture frame 204B may be displayed in the picture frame 204A and the picture content 302A from the other picture frame 204A may be displayed in the picture frame 204B. If no picture content is present in the target picture frame, then the destination picture frame will be shown as also having no picture content. In this manner, a preview of the results of a picture content swap operation between the two picture frames 204A-204B may be provided. This is illustrated in FIG. 6.

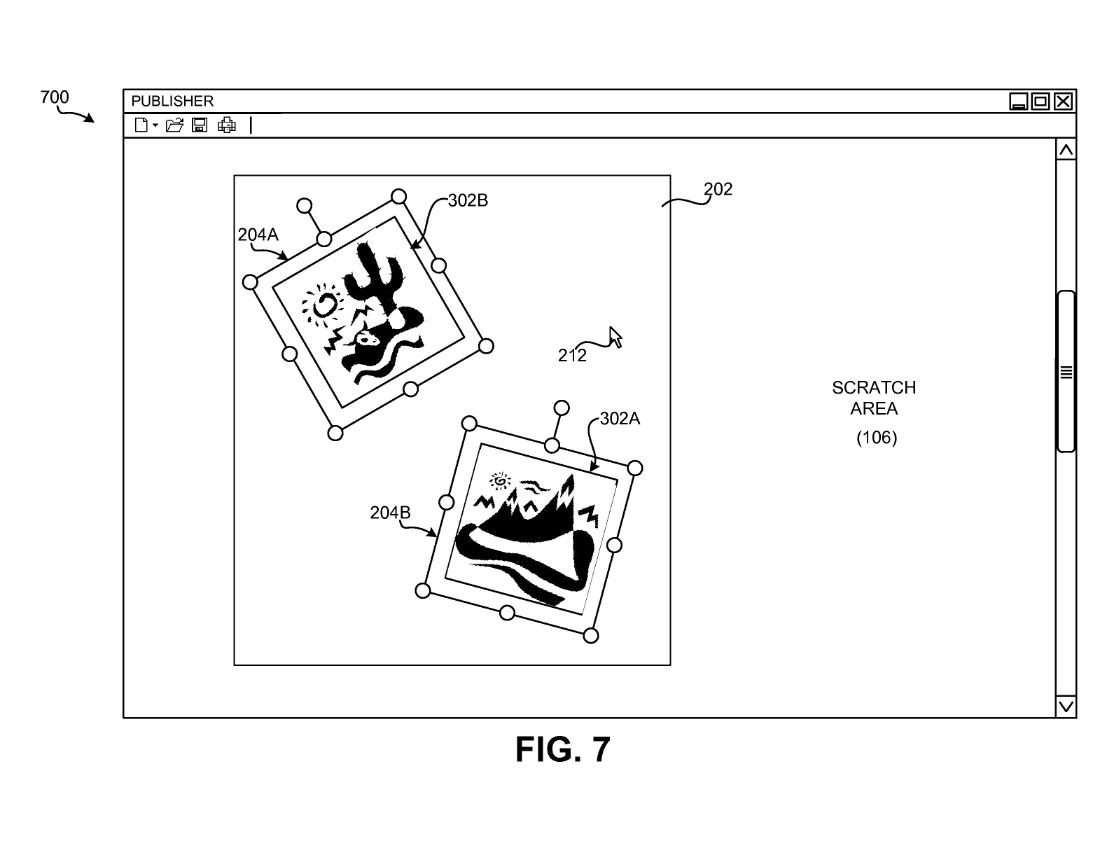

If the content icon 402 is deselected (such as, for instance, by releasing a mouse button) while the mouse cursor 212 is within a border of another picture frame 204A, the picture content 302B from the origin picture frame 204B is swapped with the picture content 302A from the destination picture frame 204A as shown in FIG. 7. This occurs without modifying the location, size, or orientation of the picture frames 204A-204B. In this manner, picture content 302 can be easily swapped between two picture frames 204.

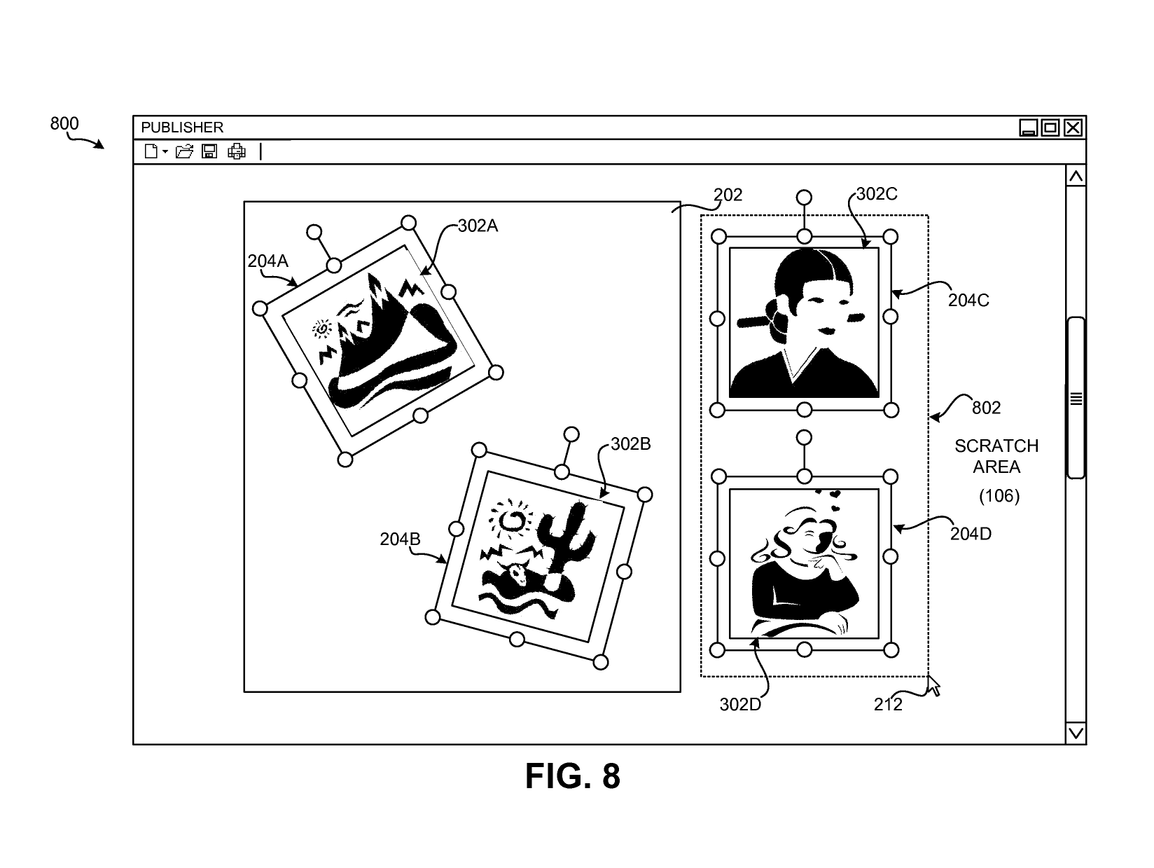

According to other aspects presented herein, multiple picture content 302A-302B in picture frames 204A-204B, respectively, in a layout 202 can be easily swapped with picture content 302C-302D located in the scratch area 106. For instance, as shown in FIG. 8, two picture frames 204A-204B have been placed in the layout 202 that contain picture content 302A-302B, respectively. Additionally, the scratch area contains two picture frames 204C-204D containing picture content 302C-302D, respectively. The mouse cursor 212 has been utilized to select both of the picture frames 204C-204D and the corresponding picture content 302C-302D.

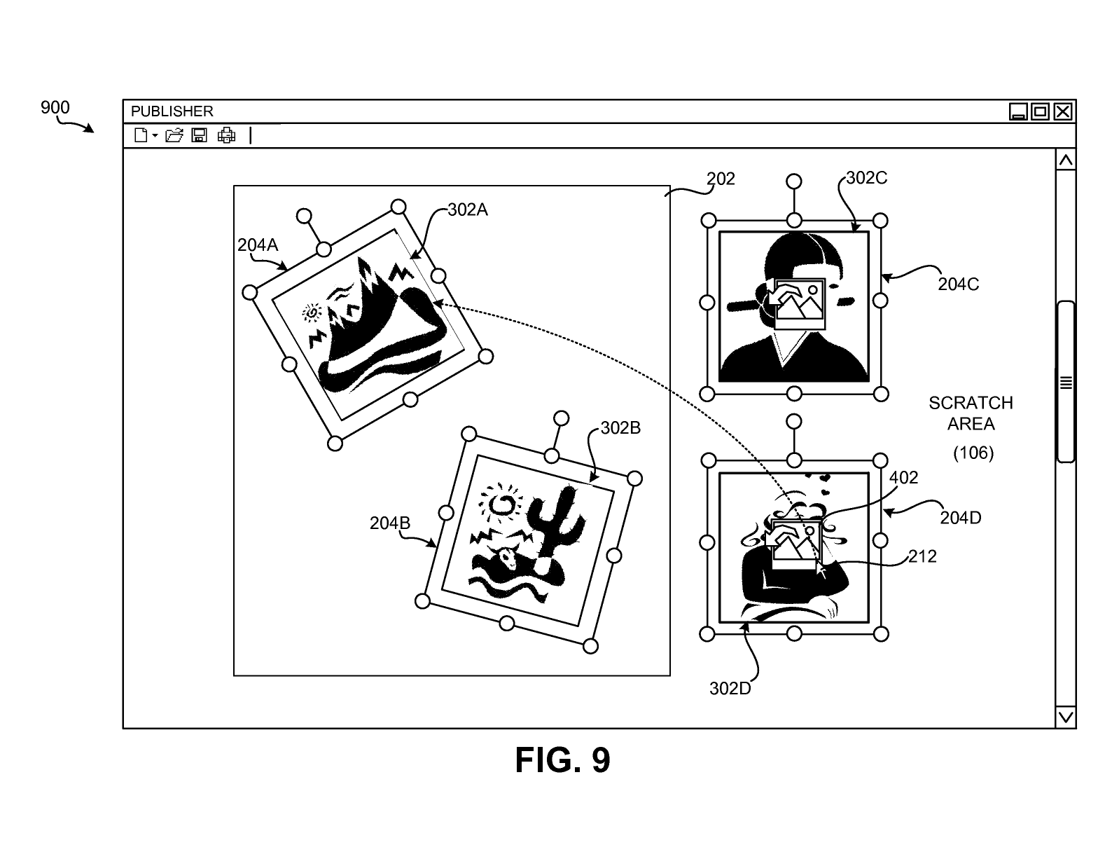

In response to the selection of the picture frames 204C-204D, a content icon 402 is displayed in each of the selected picture content 302, as shown in FIG. 9. One of the content icons 402 may be selected with the mouse cursor 212. If the mouse cursor 212 is “dragged” into the layout, the selected picture content 302 is removed from its respective picture frame and moved according to the position of the mouse cursor 212. The dragged picture content 302 might be displayed semi-transparently while being dragged.

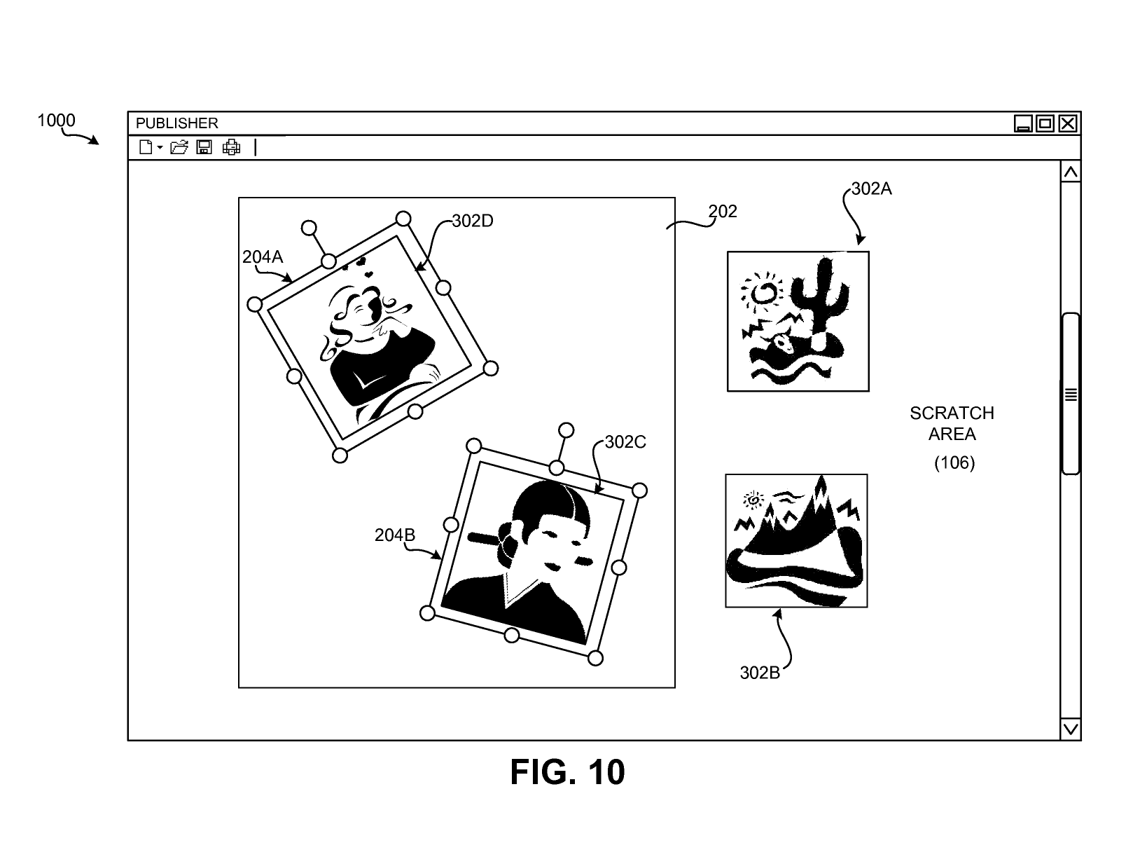

If the selected content icon 402 is deselected (such as by releasing a mouse button) while the mouse cursor 212 is within a border of one of the picture frames 204A-204B in the layout 202, the selected picture content 302C-302D will be inserted into the picture frames 204A-204B in the layout. For example, as shown in FIG. 10, the picture content 302C has been placed into the picture frame 204B and the picture content 302D has been placed into the picture frame 204A. According to embodiments, if there is picture content in the frames into which the picture content is inserted, the picture content will be moved to the scratch area. For instance, in the example shown in FIG. 10, the picture content 302A-302B is removed from the picture frames 204A-204B and placed in the scratch area 106. In this manner, multiple picture content in picture frames in the layout 202 can be replaced with picture content located in the scratch area 106 without pre-selection of the destination picture frames.

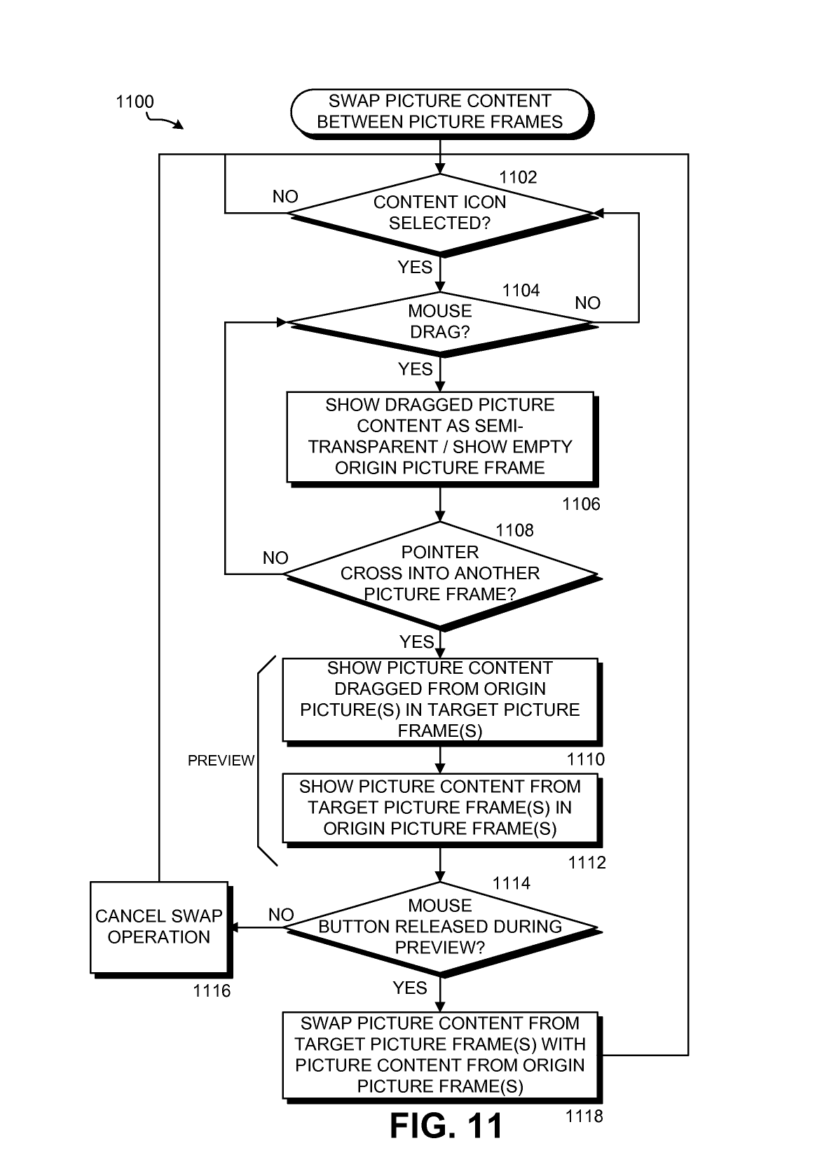

FIG. 11 is a flow diagram showing aspects of one illustrative routine 1100 disclosed herein for swapping picture content 302 between picture frames 204 in a layout 202 in the manner described above with regard to FIGS. 1-10. It should be appreciated that the logical operations described herein with respect to FIG. 11 and the other FIGURES are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

The routine 1100 begins at operation 1102, where a determination is made as to whether a content icon 402 has been selected. If so, the routine 1100 proceeds to operation 1104, where a determination is made as to whether the selected content icon 402 has been “dragged” in the manner describe above. If so, the picture content 302B corresponding to the dragged content icon 402 are removed from the associated picture frame 204B and moved with the mouse cursor 212. As described above, the selected picture content might also be displayed semi-transparently or in another manner. The picture frame 204B from which the picture content 302B was removed is also shown as being empty.

From operation 1106, the routine 1100 proceeds to operation 1108, where a determination is made as to whether the mouse pointer 212 has entered the border of another picture frame 204A. If not, the routine 1100 proceeds back to operation 1104, described above. If the mouse pointer 212 has entered the border of another picture frame 204A, the routine 1100 proceeds to operation 1110.

At operation 1110, the dragged picture content 302B is shown in the picture frame 204A (the “target” picture frame) that the mouse cursor 212 has entered. The picture content 302A is shown in the picture frame 204B (the “origin” picture frame) from which the picture content 302B was dragged. In this manner, a preview of the results of the picture content swap operation is provided to a user. This is illustrated in FIG. 6, described above.

From operation 1112, the routine 1100 proceeds to operation 1114, where a determination is made as to whether the mouse button (or another similar user input mechanism) was released while the mouse cursor 212 was located within the target picture frame 204A. In one embodiment, the picture content 302B is placed at the location of the mouse cursor 212 if the mouse button is released outside the target picture frame 204A. In another embodiment, if the mouse button is released outside the target picture frame 204A, the routine 1100 proceeds to operation 1116 where the swap operation is canceled and the picture content 302 returns to its original picture frame 204. If the mouse button is released while the mouse cursor 212 is in the target picture frame 204A, the picture content from the target picture frame 204A is swapped with the picture content from the origin picture frame 204B. In the example described above, the picture content 302B is moved to the picture frame 204A and the picture content 302A is moved to the picture frame 204B. The results of this operation are shown in FIG. 7, described above. The routine 1100 then proceeds to operation 1102, where the above-described process for swapping picture content may be repeated.

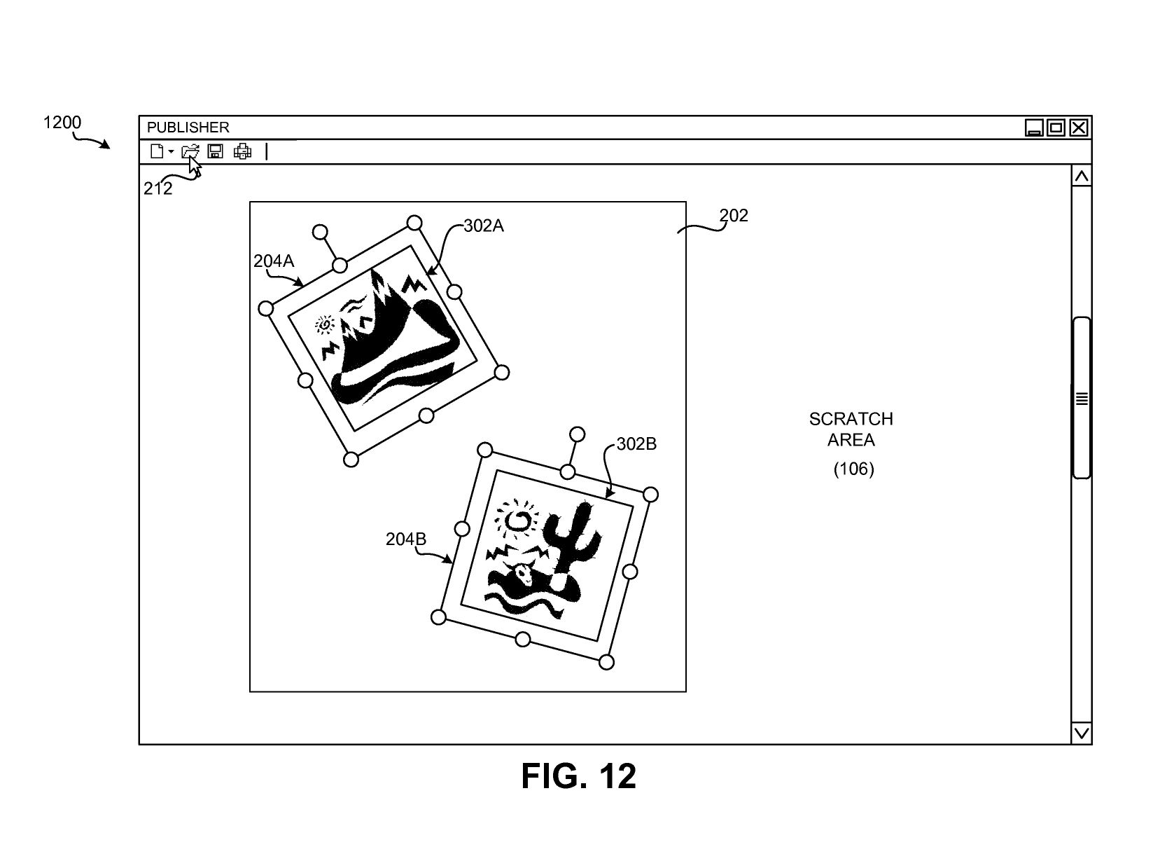

FIGS. 12-14 are user interface diagrams illustrating aspects of various embodiments disclosed herein for simultaneously replacing multiple pictures in a layout. In the example shown in FIG. 12, two picture frames 204A-204B have been placed into the layout 202. The picture frame 204A includes the picture content 302A and the picture frame 204B includes the picture content 302B. In order to initiate a replacement of the picture content 302A-302B in the picture frames 204A-204B, the picture frames 204A-204B are selected and the mouse cursor 212 is utilized to select an icon or other user interface object for initiating a replacement. Other types of user input mechanisms might also be utilized to request that the picture content 302A-302B be replaced with other picture content. Additionally, a replacement operation might be initiated without pre-selection of the picture frames 204A-204B.

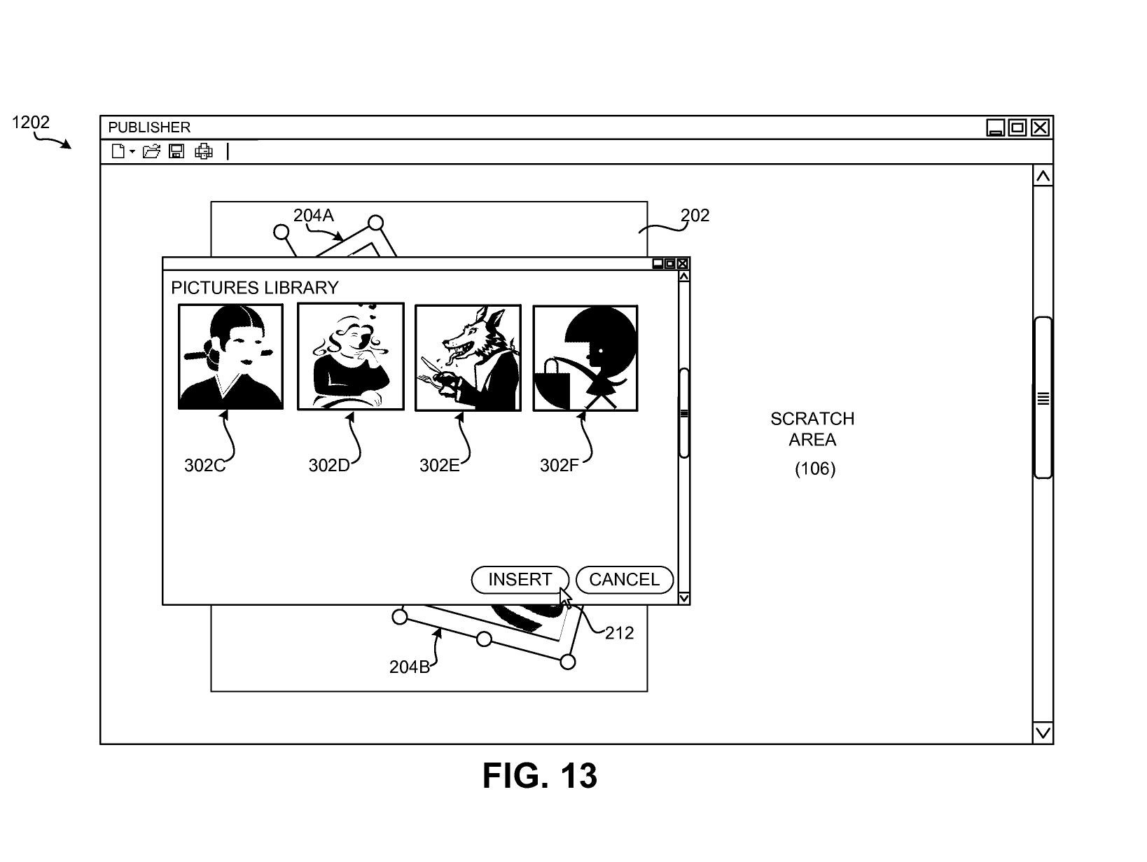

In response to receiving the request to replace the picture content in the picture frames 204A-204B, a mechanism for selecting picture content to replace the picture content 302A-302B in the picture frames 204A-204B may be provided. For instance, a file selection dialog box might be displayed allowing a user to select the picture content to replace the picture content in the picture frames 204A-204B as shown in FIG. 13. In the example shown in FIG. 13, a user has selected the picture content 302C-302F. Once the picture content has been selected, a request may then be received to replace the picture content 302A-302B in the picture frames 204A-204B in the layout with the selected picture content 302C-302F. For instance, a user may select the “insert” button with the mouse cursor 212. In response to such a request, the picture content 302A-302B in the selected picture frames is replaced with the selected picture content 302C-302F.

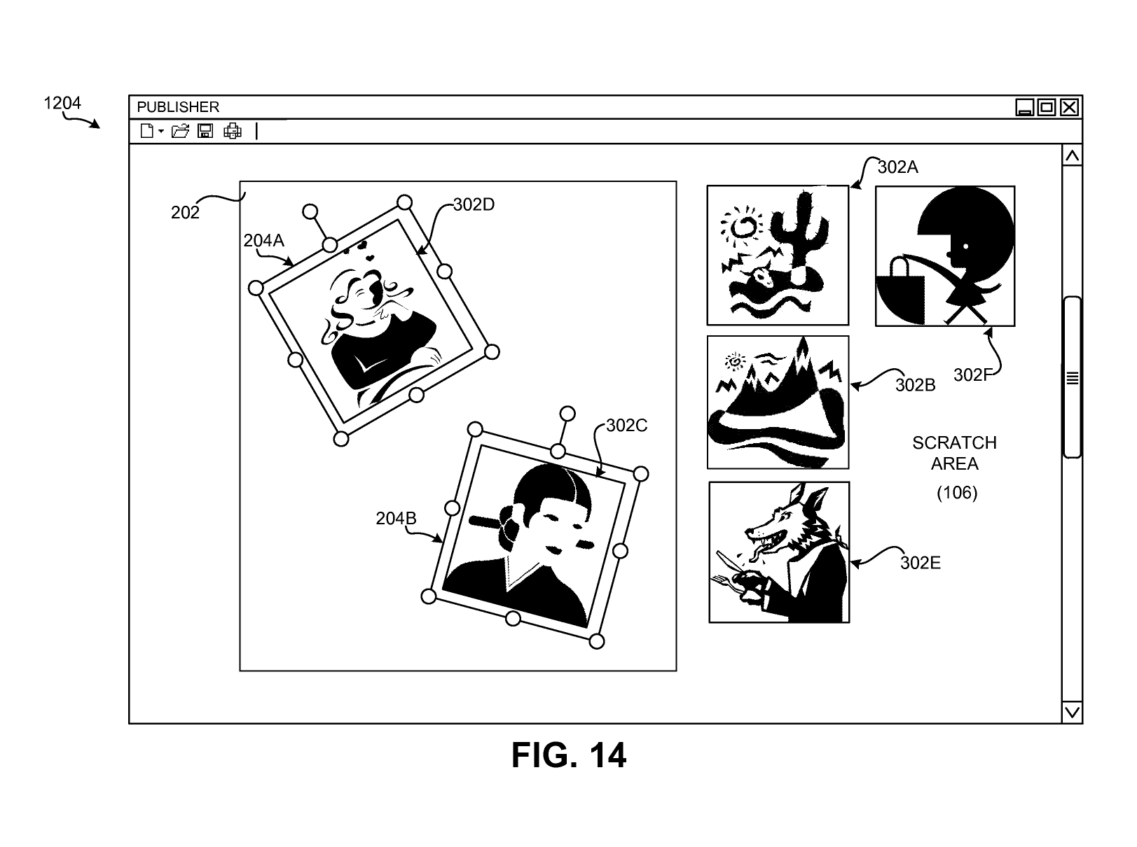

According to one embodiment, the picture content 302A-302B previously in the selected picture frames 204A-204B is moved to the scratch area 106, as shown in FIG. 14. Additionally, any content, such as the picture content 302E-302F in this example, that cannot be placed into a picture frame might also be moved to the scratch area 106. Picture content and other types of content previously in the scratch area 106 might also be moved in order to make room for the insertion of the new picture content into the scratch area. Details regarding this process will be provided below. Picture content in picture frames might also be replaced in the manner described above without pre-selecting the picture frames for which associated content should be replaced.

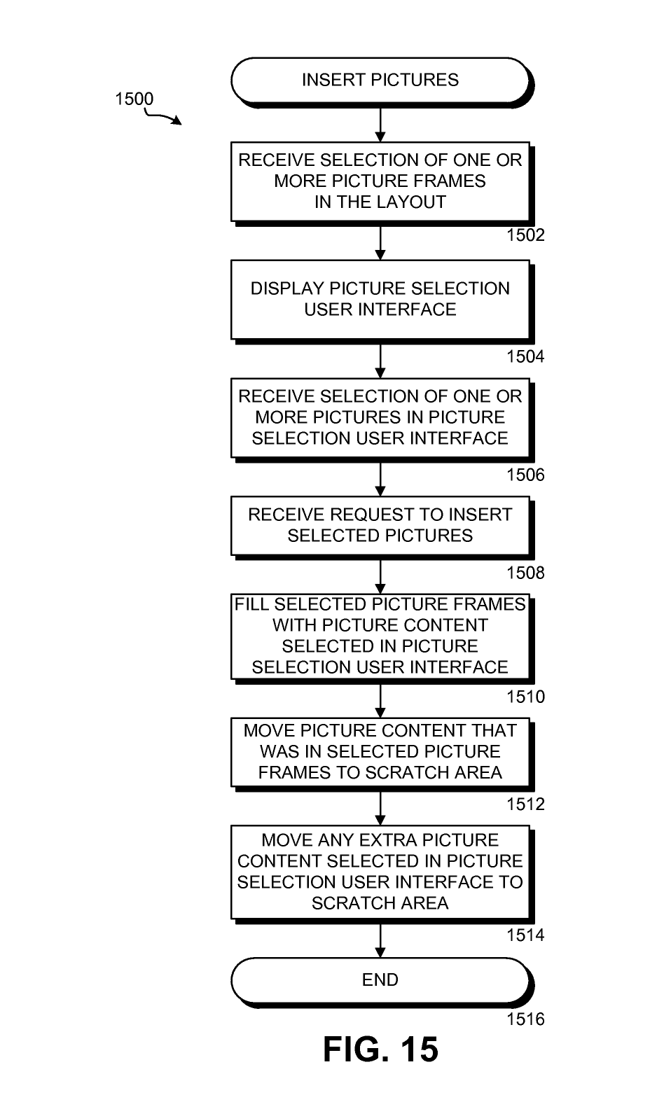

FIG. 15 is a flow diagram showing aspects of one illustrative routine 1500 disclosed herein for simultaneously replacing multiple pictures in a layout 202 in the manner described above with regard to FIGS. 12-14. The routine 1500 begins at operation 1502, where one or more picture frames 204A-204B in a layout 202 are selected. A request is then received to replace the picture content 302A-302B in the selected picture frames 204A-204B. In response thereto, a picture selection user interface, such as that shown in FIG. 13, is displayed at operation 1504. A selection is then received for one or more pictures by way of the user interface at operation 1506.

The routine 1500 then proceeds to operation 1508, where a request is received to insert the selected picture content into the selected picture frames. In the example described above, for instance, a user utilized the mouse cursor 212 to select the “insert” user interface button shown in FIG. 13. In response to receiving the request, the routine 1500 proceeds to operation 1510, where the selected picture frames 204A-204B are filled with the picture content selected through the picture selection interface. In the example shown in FIG. 14, the picture content 302D is placed into the picture frame 204A and the picture content 302C is placed into the picture frame 204B.

From operation 1510, the routine 1500 proceeds to operation 1512, where the picture content previously in the selected picture frames 204A-204B is moved to the scratch area 106. Additionally, at operation 1514, any additional picture content selected in the picture selection user interface that could not be assigned to a picture frame in the layout 202 is also moved to the scratch area 106. Content, including picture content, previously in the scratch area 106 might also be moved in order to make room for the insertion of the new picture content into the scratch area. This is illustrated in FIG. 14. From operation 1514, the routine 1500 proceeds to operation 1516, where it ends.

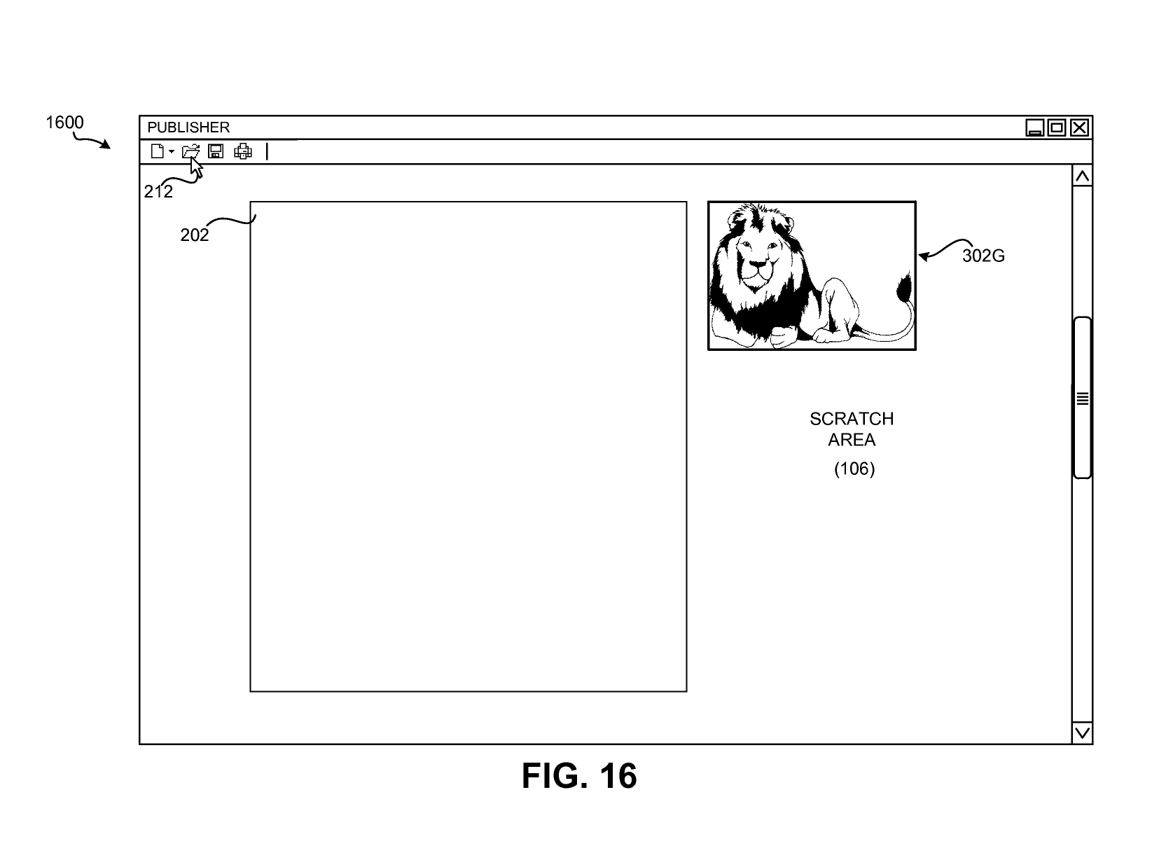

FIGS. 16-18 are user interface diagrams illustrating aspects of various embodiments disclosed herein for inserting picture content for use in a layout. In the example shown in FIG. 16, an empty layout 202 is present. Additionally, picture content 302G has been placed into the scratch area 106. In order to insert additional content for use in the layout 202, the mouse cursor 212 might be utilized to select an appropriate user interface icon or other object for requesting the insertion of picture content.

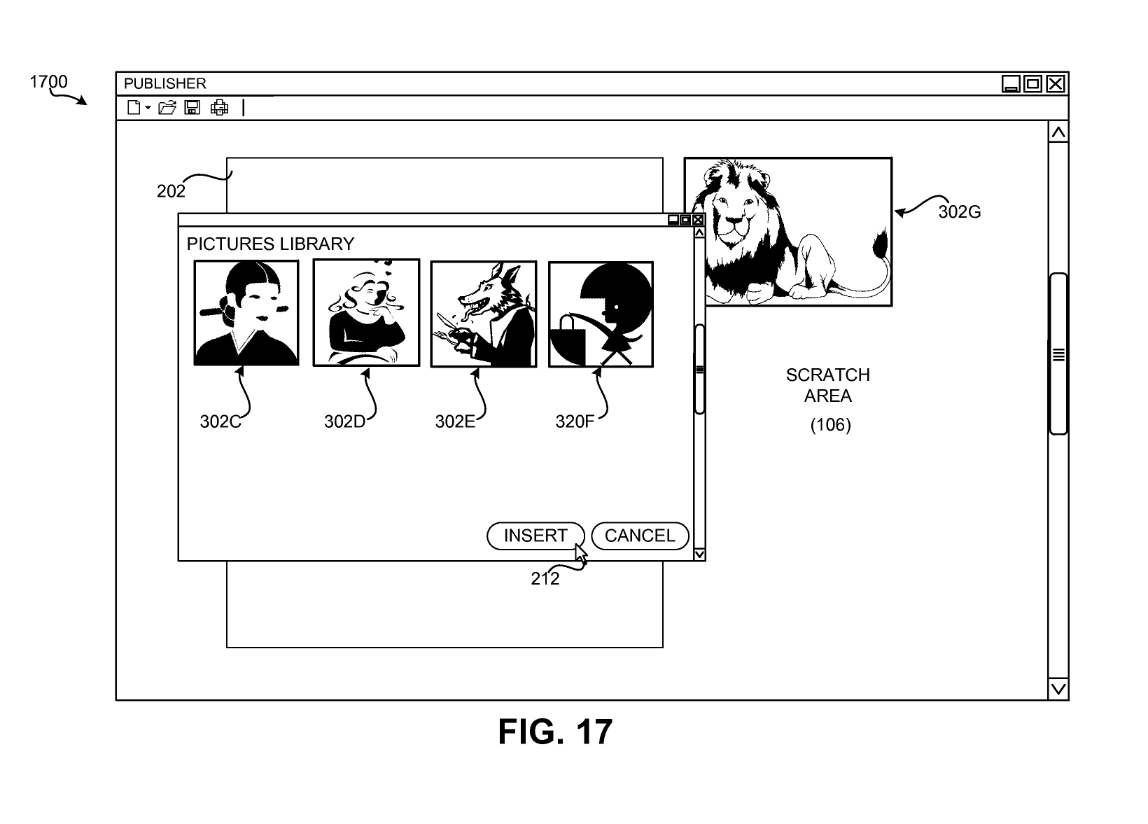

In response to receiving the request to insert picture content, a mechanism for selecting the picture content to be inserted may be provided. For instance, a file selection dialog box might be displayed allowing a user to select the picture content to be inserted as shown in FIG. 17. In the example shown in FIG. 17, a user has selected the picture content 302C-302F for insertion.

Once the picture content 302C-302F has been selected, a request may then be received to insert the selected picture content. For instance, a user may select the “insert” button with the mouse cursor 212. In response to such a request, the selected picture content 302C-302F is placed into the scratch area 106. The picture content is placed into the scratch area such that the picture content does not overlap one another. For instance, in one embodiment, the picture content inserted into the scratch area 106 is “tiled” by arranging the picture content in non-overlapping rows and columns of picture content. Other mechanisms might also be utilized to create non-overlapping arrangements of picture content.

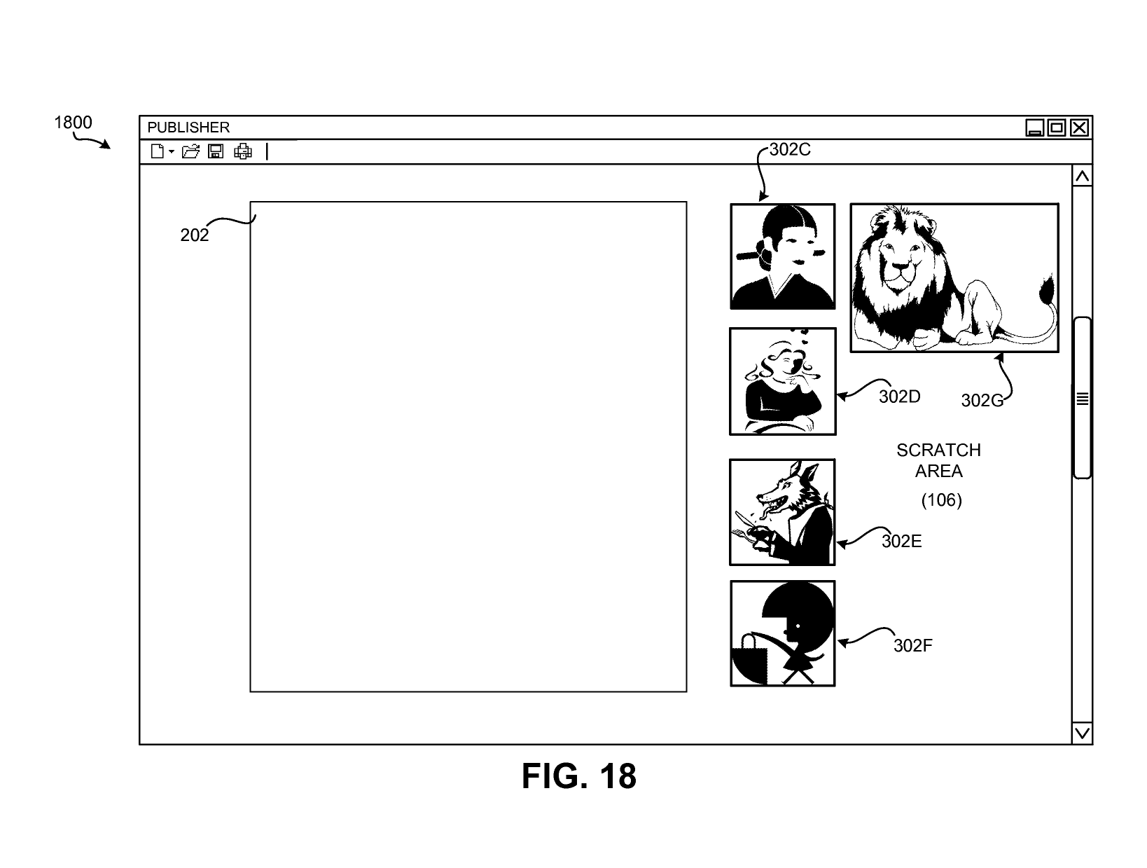

When the picture content 302C-302F is moved to the scratch area 106, it might be necessary to move picture content 302G and other types of content preexisting in the scratch area 106 to make room for the picture content 302C-302F to be inserted. In this case, the preexisting picture content 302G is shifted in order to make space for the picture content 302C-302F to be inserted as shown in FIG. 18. The picture content to be inserted 302C-302F is then placed in the created space. In this regard, the scratch area 106 might be extended indefinitely outside the viewable area of the scratch area. An appropriate user interface mechanism might be utilized to scroll through the entirety of the scratch area 106.

It should be appreciated that picture content contained in the scratch area 106 can be moved to the layout. For instance, picture content might be moved into a picture frame in the layout. Additionally, picture content in a layout can also be moved to the scratch area 106 for temporary storage. The size, location, and orientation of picture content in the scratch area 106 can also be freely arranged. In one embodiment, a command is provided for arranging picture content in the scratch area 106 in order to eliminate any overlap between the picture content. For instance, picture content in the scratch area 106 might be “tiled” by arranging the picture content in non-overlapping rows and columns of picture content. Other mechanisms might also be utilized to create non-overlapping arrangements of picture content.

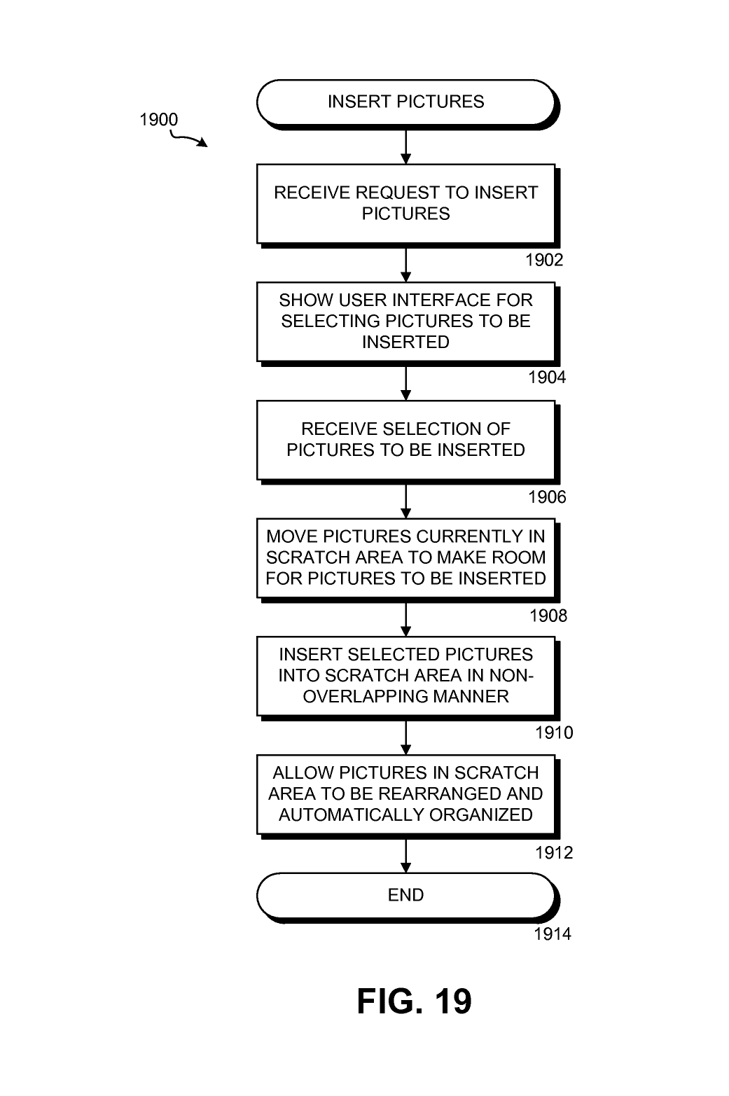

FIG. 19 is a flow diagram showing aspects of one illustrative routine 1900 disclosed herein for inserting picture content into a layout 202 in the manner described above with regard to FIGS. 16-18. The routine 1900 begins at operation 1902, where a request is received to insert picture content for use in a layout. In response to such a request, the routine 1900 proceeds to operation 1904, where a user interface for selecting the picture content to be inserted is displayed, such as that shown in FIG. 17.

From operation 1904, the routine 1900 proceeds to operation 1906, where a selection of the picture content to be inserted is received through the displayed user interface. Once the picture content to be inserted has been selected, the routine 1900 proceeds to operation 1908, where picture content currently located in the scratch area 106 is moved to make space for the picture content to be inserted. For instance, as shown in the example above, picture content might be shifted in order to make room for the picture content to be inserted.

From operation 1908, the routine 1900 proceeds to operation 1910, where the selected picture content is inserted into the scratch area 106. As discussed above, the picture content is inserted into the scratch area such that the picture content does not overlap, such as by tiling the inserted picture content as shown in FIG. 18. The routine 1900 then proceeds to operation 1912, where the picture content in the scratch area may be freely rearranged, such as by moving, resizing, and re-orienting. The picture content might also be placed into picture frames in the layout 202. Picture content in the layout 202 might also be moved to the scratch area 106. As discussed above, a command might also be provided for rearranging the picture content in the scratch area 106 such that it does not overlap. Other commands for performing functions on picture content in the scratch area 106 might also be provided. From operation 1912, the routine 1900 proceeds to operation 1914, where it ends.

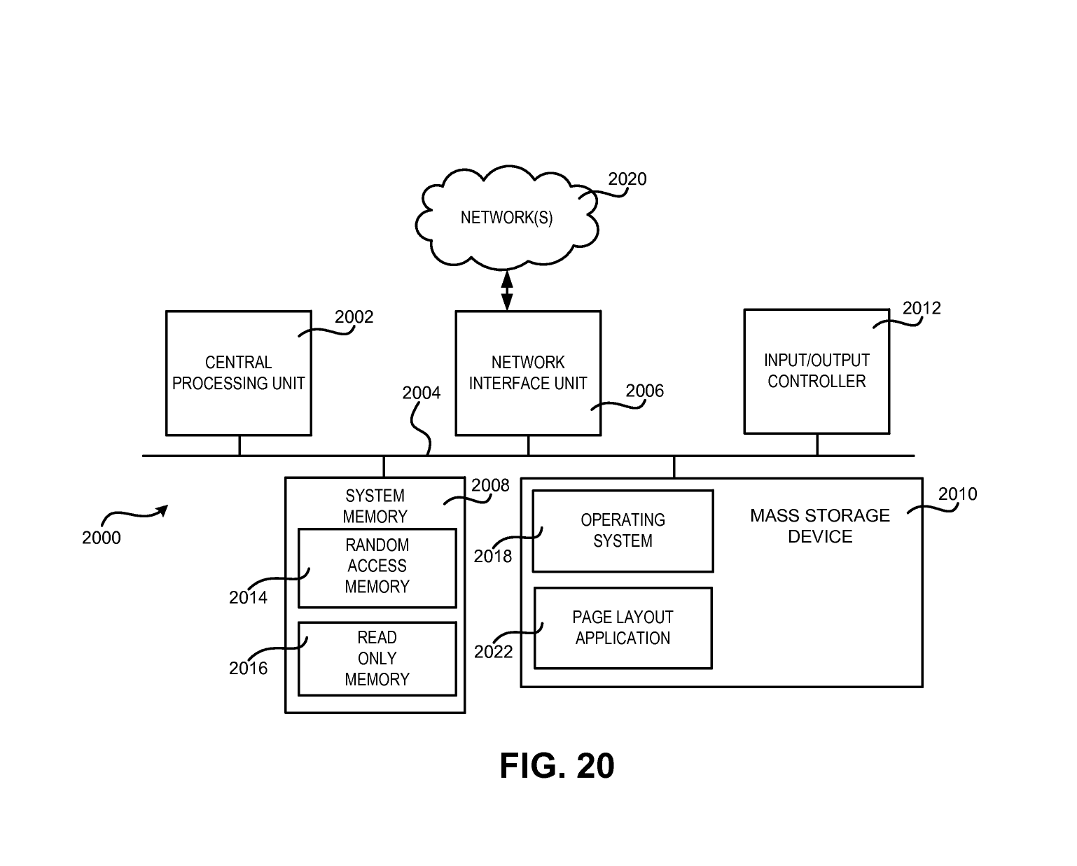

FIG. 20 is a computer architecture diagram showing an illustrative computer hardware and software architecture for a computing system capable of implementing the various embodiments presented herein. The computer architecture shown in FIG. 20 illustrates a conventional desktop, laptop computer, or server computer and may be utilized to execute various software components for providing the functionality described herein.

The computer architecture shown in FIG. 20 includes a central processing unit 2002 (“CPU”), a system memory 2008, including a random access memory 2014 (“RAM”) and a read-only memory (“ROM”) 2016, and a system bus 2004 that couples the memory to the CPU 2002. A basic input/output system (“BIOS”) (not shown) containing the basic routines that help to transfer information between elements within the computer 2000, such as during startup, is stored in the ROM 2016. The computer 2000 further includes a mass storage device 2010 for storing an operating system 2018, application programs, and other program modules, which will be described in greater detail below.

The mass storage device 2010 is connected to the CPU 2002 through a mass storage controller (not shown) connected to the bus 2004. The mass storage device 2010 and its associated computer-readable storage media provide non-volatile storage for the computer 2000. Although the description of computer-readable media contained herein refers to a mass storage device, such as a hard disk or CD-ROM drive, it should be appreciated by those skilled in the art that computer-readable storage media can be any available computer storage media that can be accessed by the computer 2000.

By way of example, and not limitation, computer-readable storage media may include volatile and non-volatile, removable and non-removable media implemented in any method or technology for storage of information such as computer-readable instructions, data structures, program modules or other data. For example, computer-readable storage media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other non-transitory medium which can be used to store the desired information and which can be accessed by the computer 2000.

It should be appreciated that the computer-readable media disclosed herein also encompasses communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media. Computer-readable storage media does not encompass communication media.

According to various embodiments, the computer 2000 may operate in a networked environment using logical connections to remote computers through a network such as the network 2020. The computer 2000 may connect to the network 2020 through a network interface unit 2006 connected to the bus 2004. It should be appreciated that the network interface unit 2006 may also be utilized to connect to other types of networks and remote computer systems. The computer 2000 may also include an input/output controller 2012 for receiving and processing input from a number of other devices, including a keyboard, mouse, or electronic stylus (not shown in FIG. 20). Similarly, an input/output controller may provide output to a display screen, a printer, or other type of output device (also not shown in FIG. 20).

As mentioned briefly above, a number of program modules and data files may be stored in the mass storage device 2010 and RAM 2014 of the computer 2000, including an operating system 2004 suitable for controlling the operation of a networked desktop, laptop, or server computer. The mass storage device 2010 and RAM 2014 may also store one or more program modules. In particular, the mass storage device 2010 and the RAM 2014 may store one or more software components for providing the functionality described above, such as a page layout application 2022, or another type of application program. The mass storage device 2010 and RAM 2014 may also store other program modules and data.

In general, software applications or modules may, when loaded into the CPU 2002 and executed, transform the CPU 2002 and the overall computer 2000 from a general-purpose computing system into a special-purpose computing system customized to perform the functionality presented herein. The CPU 2002 may be constructed from any number of transistors or other discrete circuit elements, which may individually or collectively assume any number of states. More specifically, the CPU 2002 may operate as one or more finite-state machines, in response to executable instructions contained within the software or modules. These computer-executable instructions may transform the CPU 2002 by specifying how the CPU 2002 transitions between states, thereby physically transforming the transistors or other discrete hardware elements constituting the CPU 2002.

Encoding the software or modules onto a mass storage device may also transform the physical structure of the mass storage device or associated computer readable storage media. The specific transformation of physical structure may depend on various factors, in different implementations of this description. Examples of such factors may include, but are not limited to: the technology used to implement the computer readable storage media, whether the computer readable storage media are characterized as primary or secondary storage, and the like. For example, if the computer readable storage media is implemented as semiconductor-based memory, the software or modules may transform the physical state of the semiconductor memory, when the software is encoded therein. For example, the software may transform the states of transistors, capacitors, or other discrete circuit elements constituting the semiconductor memory.

As another example, the computer readable storage media may be implemented using magnetic or optical technology. In such implementations, the software or modules may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. Other transformations of physical media are possible without departing from the scope and spirit of the present description, with the foregoing examples provided only to facilitate this discussion.

Based on the foregoing, it should be appreciated that technologies for disambiguating pictures and picture frames, swapping picture content between picture frames in a layout, simultaneously replacing multiple pictures in a layout, and for inserting pictures into a layout have been disclosed herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A computer-readable storage medium having computer-executable instructions stored thereupon which, when executed by a computer, cause the computer to:
receive a selection of one or more picture frames in a layout, each of the picture frames including picture content;
receive a selection of picture content to replace the picture content in the picture frames;
receive a request to replace the picture content in the picture frames with the selected picture content; and
in response to receiving the request, to replace the picture content in the picture frames with the selected picture content.

2. The computer-readable storage medium of claim 1, having further computer-executable instructions stored thereupon which, when executed by the computer, cause the computer to move the picture content in the picture frames to a scratch area in response to receiving the request.

3. The computer-readable storage medium of claim 2, having further computer-executable instructions stored thereupon which, when executed by the computer, cause the computer to move selected picture content that cannot be placed into a picture frame into the scratch area.

4. The computer-readable storage medium of claim 3, wherein each picture frame comprises a container for picture content having a specified location, size, and orientation within the layout.

5. The computer-readable storage medium of claim 4, wherein the picture content in the picture frames is replaced with the selected picture content without modifying a location, size, or orientation of each picture frame in the layout.

6. The computer-readable storage medium of claim 5, wherein each picture frame comprises a border, a plurality of drag handles for resizing the border, and a rotate handle for rotating the picture frame.

7. The computer-readable storage medium of claim 6, wherein the scratch area comprises an area outside the layout configured to store picture content that is not contained in the layout.

8. The computer-readable storage medium of claim 7, wherein moving selected picture content that cannot be placed into a picture frame into the scratch area comprises moving picture content previously located in the scratch area to make space for the selected picture content that cannot be placed into a picture frame and, following the moving of the picture content in the scratch area, moving selected picture content that cannot be placed into a picture frame into the scratch area.

9. A computer-implemented method, the method comprising performing computer-implemented operations for:
receiving a selection of a plurality of picture frames in a layout, each of the plurality of picture frames having picture content therein;
receiving a selection of a plurality of picture content to replace the plurality of picture content in the picture frames;
receiving a request to replace the plurality of picture content in the picture frames with the selected plurality of picture content; and
in response to receiving the request, replacing the picture content in the picture frames with the selected plurality of picture content.

10. The computer-implemented method of claim 9, further comprising moving the picture content from the plurality of picture frames to a scratch area.

11. The computer-implemented method of 10, further comprising moving selected picture content that cannot be placed into one of the plurality of picture frames into the scratch area.

12. The computer-implemented method of claim 11, wherein the scratch area comprises an area outside the layout configured to store picture content that is not contained in the layout.

13. The computer-implemented method of claim 12, wherein each picture frame comprises a container for picture content and having a specified location, size, and orientation within the layout.

14. The computer-implemented method of claim 13, wherein the picture content in the picture frames is replaced with the selected picture content without modifying a location, size, or orientation of the picture frame in the layout.

15. The computer-implemented method of claim 14, wherein each picture frame comprises a border, a plurality of drag handles for resizing the border, and a rotate handle for rotating the picture frame.

16. The computer-implemented method of claim 12, further comprising moving content preexisting in the scratch area to create space for the picture content from the plurality of picture frames in the scratch area.

17. A computer-readable storage medium having computer-executable instructions stored thereupon which, when executed by a computer, cause the computer to:
receive a selection of one or more picture frames including picture content in a layout, each of the picture frames comprising a container for picture content and having a specified location, size, and orientation within the layout;
receive a selection of picture content to replace the picture content in the picture frames;
receive a request to replace the picture content in the picture frames with the selected picture content; and
in response to receiving the request, to replace the picture content in the picture frames with the selected picture content and to move the picture content from the plurality of picture frames to a scratch area, the scratch area comprising an unmanaged area outside the layout configured to store picture content that is not contained in the layout and in which content may be freely placed, removed, arranged, and utilized.

18. The computer-readable medium of claim 17, having further computer-executable instructions stored thereupon which, when executed by the computer, cause the computer to move selected picture content that cannot be placed into a picture frame into the scratch area.

19. The computer-readable medium of claim 18, wherein the picture content in the picture frames is replaced with the selected picture content without modifying a location, size, or orientation of the picture frame in the layout.

20. The computer-readable medium of claim 19, wherein each picture frame comprises a border, a plurality of drag handles for resizing the border, and a rotate handle for rotating the picture frame.
